(19) United States
(12) Patent Application Publication
(10) Pub. No.: US 2024/0127607 A1
(43) Pub. Date: Apr. 18, 2024

(54) Pose Detection of Person in a Vehicle

(71) Applicant: Aptiv Technologies (2) S.à r.l., Luxembourg (LU)

(72) Inventors: Xuebing Zhang, Wuppertal (DE); Timo Rehfeld, Koln (DE)

(21) Appl. No.: 18/481,227

(22) Filed: Oct. 4, 2023

(30) Foreign Application Priority Data
Oct. 5, 2022 (EP) 22 199 831

(51) Int. Cl. G06V 20/59; B60R 21/015; B60R 21/16; B60W 50/14; G06T 7/70; G06V 40/16

(52) U.S. Cl. CPC G06V 20/59; B60R 21/01538; B60R 21/16; B60W 50/14; G06T 7/70; G06V 40/172; B60R 2021/01211; G06T 2207/30201; G06T 2207/30268

(57) ABSTRACT

A computerized method of pose detection of a person in a vehicle includes receiving, from an on-board camera of the vehicle, an image of an interior of the vehicle showing a seat of the vehicle occupied by the person. The computerized method includes obtaining at least one first characteristic of a first face bounding area and a first body bounding area associated with the occupied seat of the vehicle. The computerized method includes determining a second body bounding area and an associated second face bounding area of the person from the image. The computerized method includes determining at least one second characteristic of the second face bounding area and the second body bounding area. The computerized method includes determining a pose of the person based on the at least one second characteristic and on the at least one first characteristic.

### CROSS-REFERENCE TO RELATED APPLICATIONS

This application claims priority to EP App. No. 22 199 831 filed Oct. 5, 2022, the entire disclosure of which is incorporated by reference.

### FIELD

The present disclosure generally relates to safety improvements for vehicles and, in particular, to methods and systems of pose detection of a person on a vehicle seat.

### BACKGROUND

Smart vehicles, such as smart cars, smart busses, and the like, significantly improve the safety of passengers. One task in such smart vehicles is seat occupancy detection, which aims at detecting persons, objects, child seats or the like placed on a seat. Other tasks involve control functionalities such as seat belt control, airbag control, air condition control, and so forth.

Early seat occupancy detection systems were built on weight sensors for detecting weights on seats. More recent seat occupancy detection systems alternatively or additionally process images taken by cameras in the vehicle. With the development of 2D object detection, it becomes more and more popular to use object detection for support of seat occupancy detection in a vehicle's cabin. Therefore, those detected objects are assigned to seats. For this purpose, the position of the detected objection in relation to a fixed area, which is assigned to a seat, is considered.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Wrong seat assignments may happen if the object or person is in an unclear position or moves. For instance, imagine one person sitting on the seat behind the driver seat and leaning to the middle seat. In this scenario, the front seat will cover some part of the person. Hence, only the visible part of person may be taken into account and the seat occupancy system may decide to assign the person to the rear middle seat.

Since some safety means have to be controlled differently if a seat is occupied or not, there is a need for reliably detecting a seat occupancy state in the vehicle. In this context, methods, systems and computer program products are presented as defined by the independent claims.

More specifically, a computerized method of pose detection of a person in a vehicle is presented. The method includes receiving, from an on-board camera, an image of an interior of the vehicle showing a seat of the vehicle occupied by the person, obtaining at least one first characteristic of a first face bounding area and a first body bounding area associated with the occupied seat of the vehicle, determining a second body bounding area and an associated second face bounding area of the person from the image, determining at least one second characteristic of the second face bounding area and the second body bounding area, and determining a pose of the person based on at least one second characteristic and on at least one first characteristic.

In various implementations, obtaining the at least one first characteristic includes retrieving the first face bounding area and the first body bounding area from a first memory based on a facial identification of the person. In some various implementations, obtaining the at least one first characteristic includes retrieving the first face bounding area and the first body bounding area from a second memory, wherein the first face bounding area and the first body bounding area are determined based on a mean position and/or mean area of face bounding areas and body bounding areas historically captured for persons on the seat. In yet some various implementations, obtaining the at least one first characteristic includes determining the first face bounding area and the first body bounding area based on a mean position and/or mean area of face bounding areas and body bounding areas captured on a plurality of images of the interior of the vehicle for the person on the seat in a certain initialization period.

In various implementations, the at least one characteristic includes a position of a face bounding area and a position of a body bounding area. Then, determining the pose of the person includes calculating a left-right-leaning value of the person based on the position of the first face bounding area and the first body bounding area and the position of the second face bounding area and the second body bounding area and determining that the person is leaning to the right or to the left based on the left-right-leaning value.

In various implementations, the at least one characteristic includes an area covered by a face bounding area and an area covered by a body bounding area. Then, determining the pose of the person includes calculating a forward-backward-leaning value of the person based on at least two of the area of the first face bounding area, the area of the first body bounding area, the area of the second face bounding area, and area of the second body bounding area and determining that the person is leaning forward or backward based on the forward-backward-leaning value.

In various implementations, the pose detection for a seat occupancy system is used to control safety functions in the vehicle. In some various implementations, a graphical representation on a display within the vehicle is based on an output of the seat occupancy system, wherein the output of the seat occupancy system is based on at least one of the pose detection, the second body bounding area, and the second face bounding area. In yet some various implementations, the method is performed at a periodicity and/or in response to a person-to-seat assignment change of any of the seats in the vehicle.

Another aspect concerns a seat occupancy system in a vehicle including a seat assignment logic, the seat occupancy system being adapted to perform the method described herein. In various implementations, the seat assignment logic of the seat occupancy system is updated based on the determined pose, in response to determining the pose of the person. In further various implementations, updating the seat assignment logic includes adapting at least one position of a corners and/or an edge of a seat bounding area according to at least the second body bounding box. In yet further various implementations, updating the seat assignment logic includes adapting parameters associated to corners and/or edges of the seat bounding area according to at least the second body bounding box.

Yet another aspect concerns a vehicle that includes a camera for taking images of an interior of the vehicle and the seat occupancy system as described herein.

Finally, a computer program is presented that includes instructions which, when the program is executed by a computer, cause the computer to carry out the methods described herein.

Further refinements are set forth by the dependent claims.

These and other objects, various implementations and advantages will become readily apparent to those skilled in the art from the following detailed description of the various implementations having reference to the attached figures, the disclosure not being limited to any particular various implementations.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a basic flow chart of the method disclosed herein.

FIG. 2A depicts an image of an interior of a vehicle showing people on seats.

FIG. 2B depicts the same image as FIG. 2A, additionally with reference face bounding areas and reference body bounding areas.

FIG. 3 shows an overview on how the reference bounding areas and/or reference characteristics may be obtained.

FIG. 4 presents the image of FIG. 2A with current face bounding areas and current body bounding areas.

FIG. 5A shows various implementations of how it may be determined whether the person is leaning.

FIG. 5B depicts an illustration of a reference body and face bounding box and two possible current body and face bounding boxes.

FIGS. 6A and 6B present an example of different current bounding areas when the person is leaning to the right.

FIGS. 7A and 7B present an example of different current bounding areas when the person is leaning to the front.

FIG. 8 depicts an embodiment of how updating a seat bounding area may be achieved.

FIGS. 9A and 9B present an example on updating the seat bounding area.

FIG. 10 is diagrammatic representation of a computing system implementing the functionalities described herein.

In the drawings, reference numbers may be reused to identify similar and/or identical elements.

### DETAILED DESCRIPTION

The present disclosure relates to methods and systems of leaning detection in collaboration with a seat occupancy classification system that improves the safety of smart vehicles, such as cars, trains, busses, ships, and the like.

Smart vehicles already improve the safety of passengers as they detect an occupancy state of vehicle's seats. However, people do not sit motionless in cars, but typically move. Such movements may lead to false seat assignments and, thus, to false seat occupancy states. Since seat occupancy states are used, e.g., to control safety in the vehicle, such as airbag regulation, door locking, and/or seatbelt tensioning control, it is relevant to have a reliable seat assignment system in a seat occupancy system.

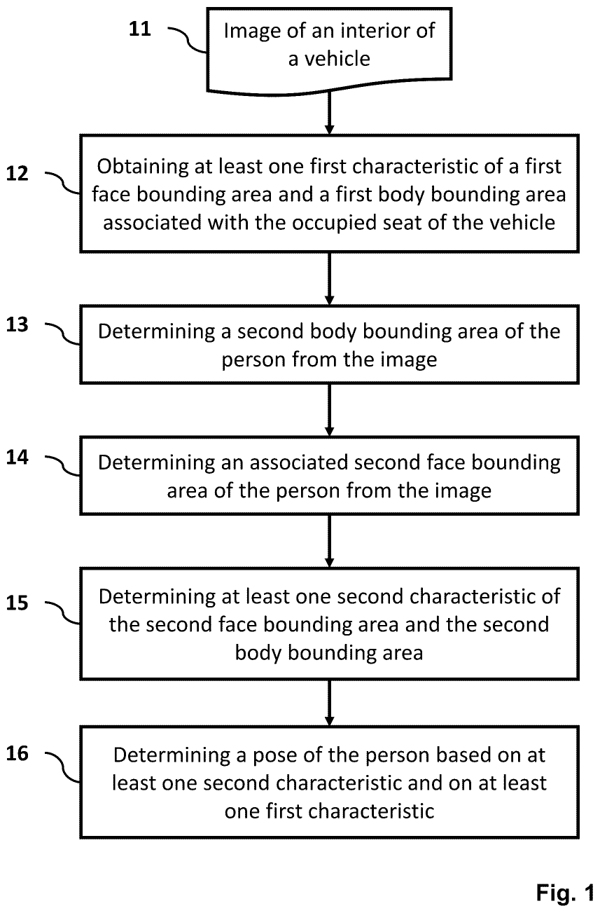

FIG. 1 is a basic flow chart of pose detection. The term pose relates to a body posture of the person occupying the vehicle seat. For example, the person may sit in an upright position on the seat. However, the person may also lean into a certain direction to a certain degree, e.g. to the left or to the right, and/or to the front. The present methodologies are directed to determining the body posture of the person on the seat, the determination result being utilized for vehicle assistance and/or control purposes such as detecting which seat is occupied by which person and controlling functionalities such as seat belts or airbags of the vehicle accordingly.

The method starts with receiving an image 11 of an interior of the vehicle showing a seat of the vehicle occupied by a person. The image 11 is also referred to as a current image because it is the latest image of the vehicle's interior, e.g., captured in the last time frame, and may show more than one person on more than one seat. This is not excluded in various implementations focusing on the leaning detection for the (one) person on the (one) seat. Hence, if there are more persons on the image, the method may be performed for each person on each seat or for a particular person of the multiple persons on a on a particular seat.

The image 11 is taken by an on-board camera of the vehicle. Such a camera is usually located in the middle of the front window above or below the rear mirror but may also be located at a different position. The camera may be an RGB camera, i.e., an imager that collects visible light (400-700 nm) and converts that to an electrical signal, then organizes that information to render images and video streams, an infrared camera, or a mixture of both (RGB-IR). The image 11 may also be processed by other modules of the vehicle, in particular, by modules of a seat occupancy system.

The method further includes in box 12 obtaining at least one first characteristic of a first face bounding area and a first body bounding area associated with the occupied seat of the vehicle. The first characteristic and first bounding areas are also referred to as reference characteristic and reference bounding area. In other words, the method includes obtaining at least one reference characteristic of a reference face bounding area and a reference body bounding area associated with the seat of the vehicle. Obtaining is to be understood broadly. Hence, obtaining may comprise retrieving the reference face bounding area and reference body bounding area from a storage and calculating or determining the at least one reference characteristic after retrieving the reference bounding areas. Obtaining may also comprise retrieving the at least one reference characteristic from a storage, wherein the at least one reference characteristic was determined before from the reference bounding areas.

The at least one reference characteristic relates to a position and/or an area of the reference face bounding area. Additionally or alternatively, the at least one reference characteristic relates to a position and/or an area of the reference body bounding area. For example, the reference characteristics may be the x and y value of the middle position of the reference bounding areas. In this example, the reference characteristics comprise four reference characteristics, namely, the x value and the y value of the center position of the reference face bounding area and the x value and the y value of the center position of the reference body bounding area. In another example, the reference characteristics may consist of six reference characteristics, namely, the x and y value of the center position of the reference bounding areas as in the example before and, additionally, the areas covered by the reference bounding areas. Any other combinations or other values relating to the position (i.e., corner coordinates etc.) may be obtained, too.

A bounding area is a 2D area around an object. In the present disclosure, bounding areas are determined around bodies and faces detected on images of the interior of the vehicle. A bounding area may be a rectangle, i.e., a bounding box, any kind of polygon, or even a circle. Bounding boxes may be defined by at least a width, a height, a center x position, and a center y position relative to an image taken by the on-board camera. The bounding area may be a minimum bounding area, i.e., the smallest area with the defined shape (and in some various implementations also orientation) around the body or face of the person or, e.g., around a seat. For determining bounding areas, e.g., bounding boxes around the body or face of a person, a YOLO (you only look once) algorithm may be used. Other machine learning algorithms or conventional image processing and recognition algorithms may be used, too.

In box 13, the method determines a second body bounding area of the person from the image. The second body bounding area is herein also referred to as a current body bounding area, which is determined around a body of the person based on the current image 11. Therefore, as explained above, algorithms for object detection and bounding area determination can be applied to determine the current body bounding area. In some various implementations, the current body bounding area may be determined by modules of the seat occupancy system.

In box 14, the method determines an associated second face bounding area of the person from the image. The second face bounding area is also referred to as a current face bounding area determined around a face of the person based on the current image 11. Therefore, as explained above, algorithms for object detection and bounding area determination can be used to determine the current face bounding area. In some various implementations, the current face bounding area may be determined by modules of the seat occupancy system.

Based on the determined current bounding areas around the face and the body, the method determines in box 15 at least one second characteristic, i.e., current characteristic, of the second face bounding area and the second body bounding area. The at least one current characteristic relates to the position and/or area of the current face bounding area and/or current body bounding area. Hence, in some various implementations, the determination of the at least one current characteristic may be analogue to the determination of the at least one reference characteristic of box 12.

Finally, the method includes in box 16 determining a pose of the person based on at least one second characteristic and on at least one first characteristic. A pose may comprise a leaning to a direction. The direction may comprise left, right, forward, or backward. Additionally or alternatively, the direction may comprise diagonally left forward, diagonally right forward, and the like. Other poses may comprise kneeling, laying, and the like.

As will be apparent to the skilled person, the order of the processed depicted in boxes 11 to 15 can be different compared to the order shown in FIG. 1. For example, obtaining at least one reference characteristic of box 12 can be done once and before executing the further processes, i.e., also before receiving the current image 11. Alternatively, obtaining at least one reference characteristic of box 12 can be done after determining the current body and face bounding areas (boxes 13 and 14) and/or after box 15, i.e., after determining the at least one current characteristic. Changing the order of processes depicted in boxed 13 and 14 is also apparent to the skilled person. In summary, when describing a method that includes specific processes, reordering of the processes is to be understood to be comprised as long as no technical hurdle contradicts a reordering.

The method of FIG. 1 may be performed at a periodicity, e.g., every 10 seconds, every minute, or the like. The periodicity may be pre-defined and/or configurable by a passenger. Periodic execution in short intervals can assure that a seat bounding area associated to a respective seat is always up to date according to a determined leaning of a person sitting on that seat. Hence, the seat occupancy system can more reliably assign persons to seats.

Alternatively or additionally, the method of FIG. 1 may also be executed in response to a person-to-seat assignment change of any of the seats in the vehicle. For example, if the seat occupancy system detects a movement of a person from one seat to another, i.e., assigns the person to another seat than previously, the method may be executed in order to determine whether the person is leaning towards the other seat, but actually still sitting on the previously assigned seat, or whether the person has really moved to the other seat. Since the seat occupancy system is used to control safety functions in the vehicle, such as airbag or belt control, the leaning detection may be at least indirectly also be used to control the safety functions, i.e. for controlling the airbag strength according to the leaning direction.

The output of the seat occupancy system can also comprise knowledge derived from the leaning detection as described herein, e.g., in order to present a seat occupancy status of a seat to the passengers and/or driver of the vehicle on a display. The output of the seat occupancy system may in such an example be based on at least one of the leaning detection, the current body bounding area, and the current face bounding area. In some various implementations, a smart display, an infotainment system, or another media system in the vehicle may then present the passengers with a seat occupancy status of the seats and, e.g., may indicate whether the person-to-seat assignment was based on a leaning detection. If the leaning detection and/or the person-to-seat assignment is uncertain (e.g., a confidence value is below a threshold or the like), the passengers could interact with the media system in order to change or verify the assignment manually.

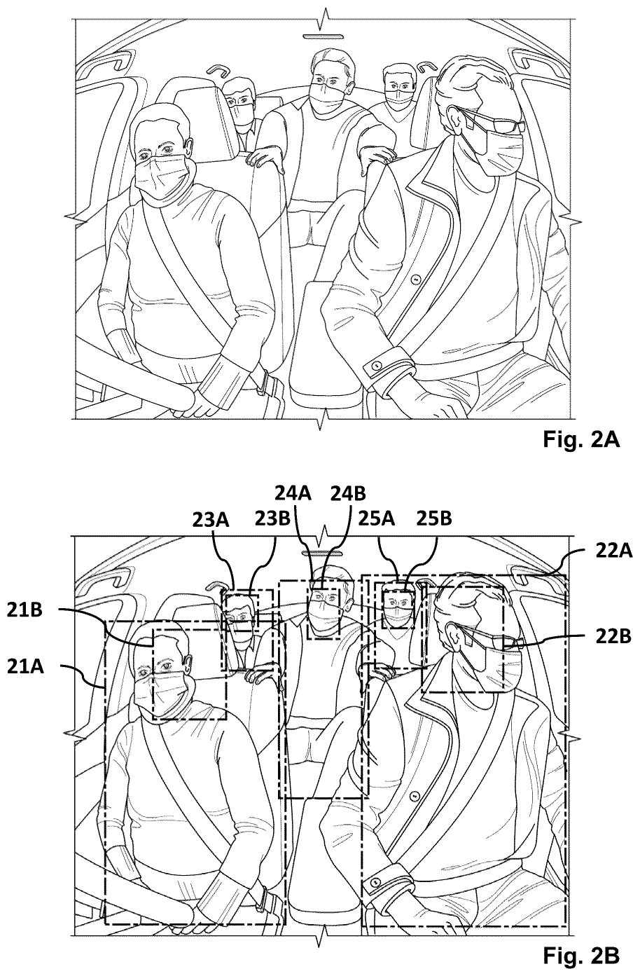

FIG. 2A depicts an image of an interior of a vehicle showing people on seats. In this example, this image may correspond to the current image 11. Five persons are sitting on the five seats of the vehicle. The driver seat is on the left-hand side in the front, the passenger seat to the right of the driver seat, and the three rear seats are behind the two front seats.

FIG. 2B depicts the same image as FIG. 2A but with additional reference face bounding areas and reference body bounding areas; in this example, but not limiting, the bounding areas shown are bounding boxes. Although the bounding areas are not determined based on the current image but on at least one reference image, e.g., previously taken from the on-board camera, the reference bounding areas are for highlighting purposes depicted within the current image. As can be seen, the reference bounding areas are not bounding areas of the persons in the current image. E.g., the driver's reference body bounding area 21A and the driver's reference face bounding area 21B are shifted a little to the right, since the driver is leaning slightly to the left (from the camera's view). The co-driver's reference body bounding area 22A and the co-driver's reference face bounding area 22B do also not completely surround the body or face of the co-driver. Further smaller discrepancies can also be seen for the other passengers' reference bounding areas 23A, 23B, 24A, 24B, 25A, and 25B.

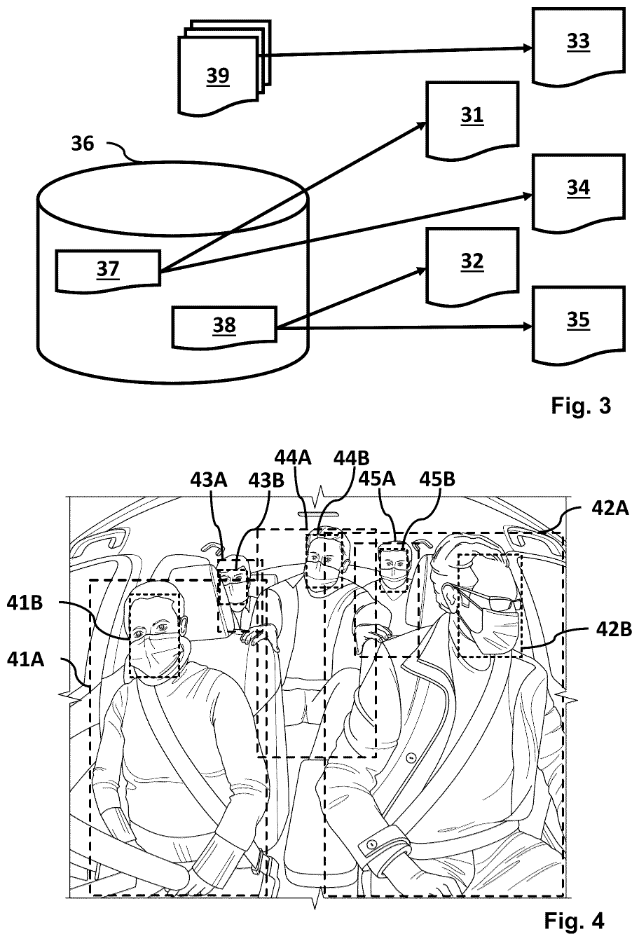

According to the method described with respect to FIG. 1, the reference characteristic(s) of the reference bounding area(s) have to be obtained in box 12. There are different approaches how these can be obtained, which are presented in FIG. 3. In this example, it is assumed that reference characteristics for five passenger seats in a vehicle shall be received (i.e., performing the method of FIG. 1 five times). These are reference characteristic 31 for the driver's seat, reference characteristic 32 for the co-driver's seat, reference characteristic 33 for the left rear seat (from camera perspective), reference characteristic 34 for the middle rear seat, and reference characteristic 35 for the right rear seat.

In the example of FIG. 3, the reference characteristic 31 may be retrieved from a storage or memory 36 based on a facial identification of the person. Facial identification, briefly referred to as faceID, uses biometric recognition on persons' faces in the vehicle. With the help of faceID, a unique identifier can be associated with a person and with the biometrics of this person. This enables to individually adapt the vehicle's features to the person, e.g., moving the driver's seat in the correct position, loading the driver's profile on a display in the vehicle, i.e., on the vehicle's infotainment system, or the like. FaceID can also be used to store and retrieve reference characteristic(s) of reference bounding area(s) of a specific passenger sitting on a specific seat, e.g., stored reference characteristics 37. In the example of FIG. 3, the reference characteristic 34 of the middle rear seat, e.g., the already known child of the driver, is obtained in the same way.

As depicted in FIG. 3, reference characteristics of other seats can be retrieved differently. In the example of FIG. 3, the reference characteristic 32 associated with the co-driver's seat may also be retrieved from the memory 36 but not by using a faceID but only the location or identification of the respective seat. The reference characteristic 32 may then be determined based on a mean position and/or area of a historical reference bounding areas determined for one or more persons that were historically, e.g., in the last days, weeks, months etc., sitting on the respective seat, e.g., stored reference characteristics 38. In the example of FIG. 3, the reference characteristic 35 of the right rear seat is obtained in the same way.

One further example of obtaining the reference characteristic(s) is determining the reference characteristic(s) based on a mean position and/or mean area of bounding areas determined on a plurality of images of the interior of the vehicle for the person on the seat in an initialization period. In the example of FIG. 3, the reference characteristic 33 is determined by considering images 39 taken by the on-board camera during the initialization period. The initialization period may be a period after starting the computing systems of the vehicle, e.g., after opening the door or after starting the engine. Alternatively, the initialization period may also be a period during use of the vehicle, e.g., started by a passenger via a smart display/driving assistance infotainment system or starting by the seat occupancy system if seat occupancy detection has failed, led to uncertain states or was corrected by a passenger several times.

However, although not shown in FIG. 3, reference characteristics 31, 32, 33, 34, and 35 of the seats may also all be obtained similarly, e.g., all based on faceID if available, all based on historical mean bounding boxes on the respective seat if available, or all based on bounding boxes determined on images taken during an initialization period. Moreover, in some various implementations, the storages do not store the reference characteristics as such but the (mean) reference bounding areas. In such various implementations, obtaining the at least one reference characteristic includes, after retrieving the mean reference bounding areas from the memory 36, determining the at least one reference characteristic from the stored reference bounding areas.

The method of FIG. 1 also includes—in boxes 13 and 14—determining current face and body bounding areas. FIG. 4 presents an example on how the current face bounding areas and current body bounding areas, in this example again bounding boxes, may look like in the image of FIG. 2A. The driver's body bounding box 41A and her face bounding box 41B are now aligned with the body and the face. The same is true for all other body bounding boxes 42A, 43A, 44A, and 45A, as well as for all other face bounding boxes 42B, 43B, 44B, and 45B.

Based on at least one current characteristic of at least one current bounding area 41A, 41B, 42A, 42B, 43A, 43B, 44A, 44B, 45A, and 45B associated to a seat and on at least one reference characteristic of at least one reference bounding area 21A, 21B, 22A, 22B, 23A, 23B, 24A, 24B, 25A, and 25B, it can now be determined whether the person is leaning.

For example, consider the person on the middle rear seat. The areas covered by the reference body bounding box 24A and the reference face bounding box 24B are smaller than the areas covered by the current body bounding box 44A and the current face bounding box 44B. Hence, based on this, it can be determined that the person is—at least slightly—leaning to the front. Or consider the driver. It can be determined that she is leaning to the left based on the change of the current body bounding box 41A and the current face bounding box 41B with respect to the center position of the reference body bounding box 21A and the reference face bounding box 21B.

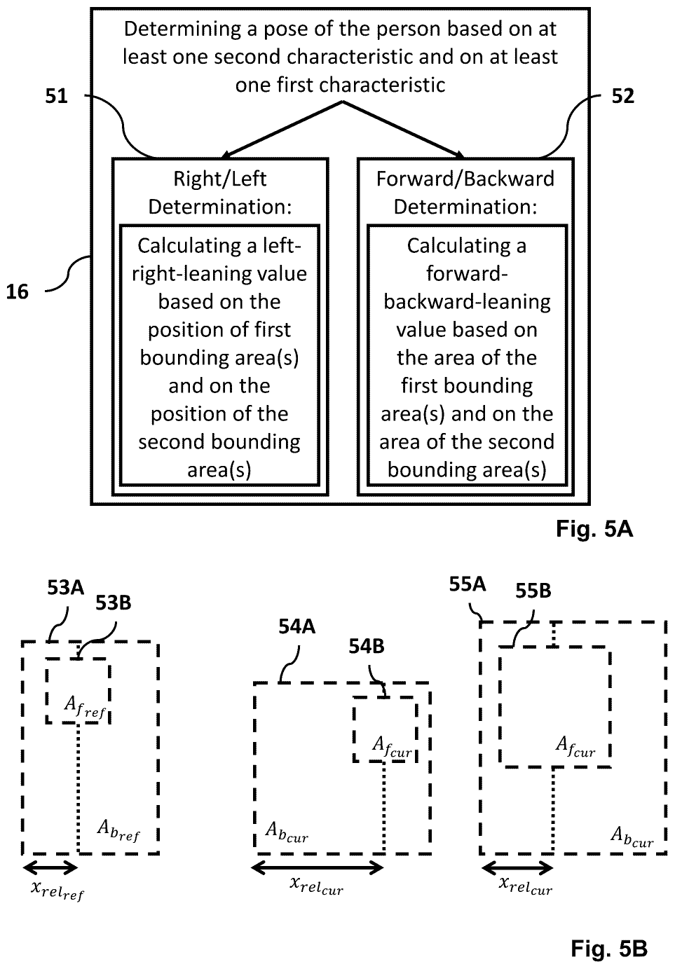

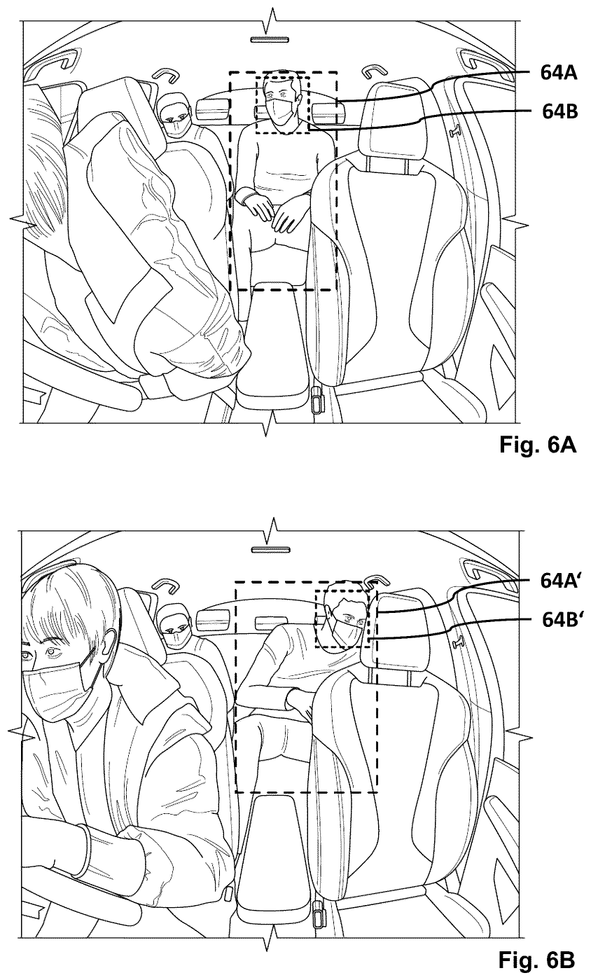

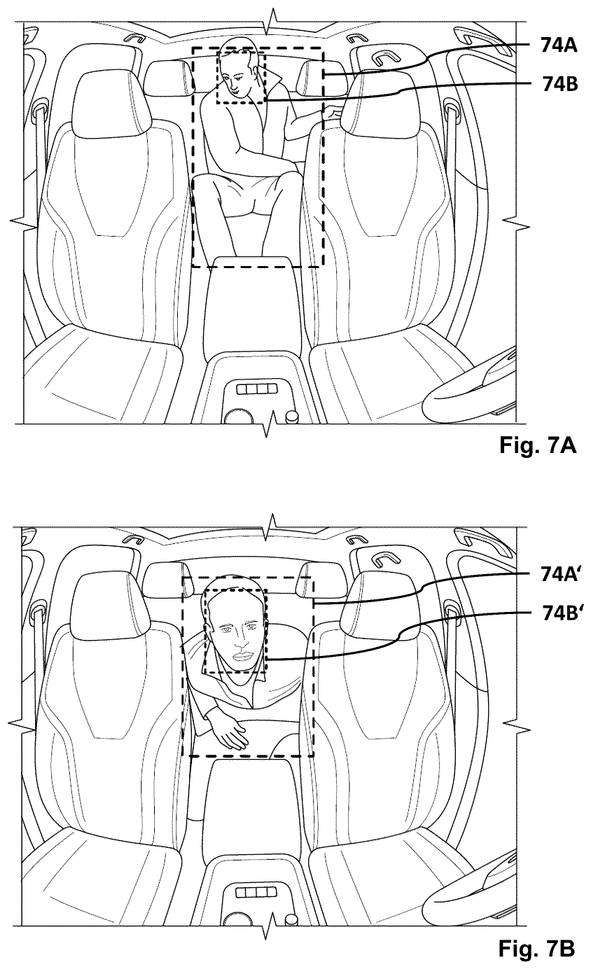

FIG. 5A depicts a simplified diagram of how it may be determined whether the person is leaning when determining the pose of the person, e.g., a further refinement of box 16 as also presented in FIG. 1. Specific examples on how the leaning may be determined will be described in the following on the examples of FIGS. 6A and 6B and FIGS. 7A and 7B.

Determining whether the person is leaning may comprise two determination steps, one for determining whether the person is leaning to the right or to the left, which is shown in box 51, and one for determining whether the person is leaning to the front or to the back, which is shown in box 51. Although both determination processes are depicted in FIG. 5A, a leaning determination according to the methods described herein may also comprise one of both or even none of both but another leaning determination process, e.g., one process determining the leaning direction in 3D, e.g., right, left, front, backward, diagonally, and the like.

The right/left determination as shown in box 51 includes calculating a left-right-leaning value based on the position of first bounding area(s) and on the position of the second bounding area(s), e.g., calculating a left-right-leaning value of the person based on at least one of the center position of the reference face bounding area and the reference body bounding area, and on at least one of the center position of the current face bounding area and the current body bounding area. Based on the left-right-leaning leaning value, it is then determined that the person is leaning to the right or to the left. Different calculations may be considered. FIG. 5B illustrates bounding boxes for the following explanations.

For example, the reference characteristic may be determined as the center x-position of the reference face bounding box relative to the reference body bounding box. Such a reference characteristic xᵣₑₗ_{_{ref}} is depicted on the left-hand side of FIG. 5B for the reference body bounding box 53A and reference face bounding box 53B. The current characteristic may be determined as the center x-position of the current face bounding box relative to the current body bounding box, which is also depicted as xᵣₑₗ_{_{cur}} for the two example current body bounding boxes 54A and 55A with their respective current face bounding boxes 54B and 55B.

The left-right-leaning value Pₗₑₐₙ_{ᵣₗ} may then be determined by:

Pₗₑₐₙ_{ᵣₗ}=xᵣₑₗ_{_{cur}}−xᵣₑₗ_{_{ref}} (1)

In this example, if the left-right-leaning value Pₗₑₐₙ_{ᵣᵢ} is negative, the person is determined to be leaning to the left, if the left-right-leaning value Pₗₑₐₙ_{ᵣₗ} is positive the person is determined to be leaning to the right, which is e.g. the case for the current body bounding box 54A and face body bounding box 54B relative to the reference bounding boxes 53A and 53B. Hence, a mathematic sign of the left-right leaning value indicates the direction of leaning. Moreover, the left-right leaning value also indicates the extent of the leaning.

In some various implementations, a threshold is set in order to determine that a person is leaning, i.e., to prevent that also small deviations are already determined as leaning, i.e., the small deviation of the current bounding boxes 55A and 55B with respect to the reference bounding boxes 53A and 53B. For example, if the left-right-leaning value Pₗₑₐₙ_{ᵣᵢ} can usually take values between −5 and +5, a possible threshold may be set to 1. This means, an unsigned left-right-leaning value |Pₗₑₐₙ_{ᵣᵢ}| that is larger than the threshold will lead to a person being determined as leaning.

In a more specific example, a weighting parameter may also be applied to the above-mentioned formula (1) in order to also take the size or position of the bounding boxes into account. This may, e.g., be the case of bounding boxes 55A and 55B in FIG. 5B. For example, the weighting parameter may be based on the expansion in x-direction of the reference body bounding box (xₑₓₚ_{_{ref}}), the area covered by the reference body bounding box (A_{b}_{_{ref}}) and/or of the current body bounding box (A_{b}_{_{cur}}), or the x-position of the reference face bounding box relative to the reference body bounding box, i.e., the reference characteristic (xᵣₑₗ_{_{ref}}). Further factors f, e.g. 0.1, 0.5, 2, or the like, can be used to normalize the values of Pₗₑₐₙ_{ᵣₗ}. Possible formulas are:

$$\begin{matrix}{P}_{{learn}_{rl}} = \frac{{x}_{{rel}_{cur}} - {x}_{{rel}_{ref}}}{f * {x}_{{exp}_{ref}}} & ( 2 ) \\ {P}_{{lean}_{rl}} = \frac{{x}_{{rel}_{cur}}}{{A}_{{b}_{cur}}} - \frac{{x}_{{rel}_{ref}}}{{A}_{{b}_{ref}}} & ( 3 ) \\ {O}_{{lean}_{rl}} = \frac{{x}_{{rel}_{curr}} - {x}_{{rel}_{ref}}}{f * {A}_{{b}_{ref}}} & ( 4 ) \\ {P}_{{lean}_{rl}} = \frac{{x}_{{rel}_{cur}} - {x}_{{rel}_{ref}}}{f * {x}_{{rel}_{ref}}} & ( 5 )\end{matrix}$$

The forward/backward determination as shown in box 52 includes calculating a forward-backward-leaning value based on the area of the first bounding area(s) and on the area of the second bounding area(s), e.g., calculating a forward-backward-leaning value of the person based on at least one of the area of the reference face bounding area and the area of the reference body bounding area, and on at least one of the area of the current face bounding area and area of the current body bounding area. Based on this leaning value, it is then determined that the person is leaning to the front or to the back. Different calculations may be considered. FIG. 5B also illustrates bounding boxes for the following explanations.

For example, the reference characteristic may be determined as the area covered by the reference face bounding box A_{f}_{_{ref}} relative to the area covered by the reference body bounding box A_{b}_{_{ref}}, as also illustrated in FIG. 5B for bounding boxes 53A and 53B. The current characteristic may be determined as the area covered by the current face bounding box A_{f}_{_{cur}} relative to the area covered by the current body bounding box A_{b}_{_{cur}}, as also illustrated in FIG. 5B for bounding boxes 54A, 54B, 55A, and 55B. The forward-backward-leaning value Pₗₑₐₙ_{_{fb}} may then be determined by:

$${P}_{{lean}_{fb}} = \frac{{A}_{{f}_{cur}}}{{A}_{{b}_{cur}}} - \frac{{A}_{{f}_{ref}}}{{A}_{{b}_{ref}}} \qquad ( 6 )$$

In this example, if the forward-backward-leaning value Pₗₑₐₙ_{_{fb}} is negative, the person is determined to be leaning to the back, if the forward-backward-leaning value Pₗₑₐₙ_{_{fb}} is positive the person is determined to be leaning to the front. Hence, a mathematic sign of the forward-backward-leaning value indicates the direction of leaning. Moreover, the forward-backward-leaning value also indicates the extent of the leaning.

In some various implementations, a threshold is set in order to determine that a person is leaning, i.e., to prevent that also small deviations are already determined as leaning. For example, if the forward-backward-leaning value Pₗₑₐₙ_{_{fb}} can usually take values between −0.5 and +0.5, a possible threshold may be set to 0.1. This means, an unsigned forward-backward-leaning value |Pₗₑₐₙ_{_{fb}}| that is larger than the threshold will lead to a person being determined as leaning.

In some various implementations, determining whether the person is leaning to the front or to the back may additionally take the current body bounding box side ratio into account. For example, if the sides are almost equal, i.e., a ratio 1:1 and the forward-backward-leaning value indicates a forward leaning, the person may be more reliably determined as leaning to the front, which is the case for the current body bounding box 55A of FIG. 5A. Otherwise, e.g., if the ratio is 2:1 (like for the reference body bounding box 53A) but the forward-backward-leaning value indicates a forward leaning, the person may not be determined as leaning to the front.

FIGS. 6A and 6B present an example of different current bounding areas when the person is leaning to the right. It is assumed that the current body bounding area 64A of FIG. 6A is very similar to the reference body bounding area. It is further assumed that the current face bounding area 64B of FIG. 6A is also very similar to the reference face bounding area. Hence, when the current bounding areas of FIG. 6A are determined and the respective current characteristics are compared to the reference characteristics, the method of FIG. 1 will determine that the person is not leaning.

In contrast to the case of FIG. 6B. There, the current body bounding box 64A′ and the current face bounding boy 64B′ have changed their shape and position. Hence, the method as described herein will determine that the person is leaning to the right.

FIGS. 7A and 7B present an example of different current bounding areas when the person is leaning to the front. It is assumed that the current body bounding area 74A of FIG. 7A is very similar to the reference body bounding area. It is further assumed that the current face bounding area 74B of FIG. 7A is also very similar to the reference face bounding area. Hence, when the current bounding areas of FIG. 7A are determined and the respective current characteristics are compared to the reference characteristics, the method of FIG. 1 will determine that the person is not leaning.

In contrast to the case of FIG. 7B. There, the current body bounding box 74A′ and the current face bounding boy 74B′ have changed their shape and position. Hence, the method as described herein will determine that the person is leaning to the front.

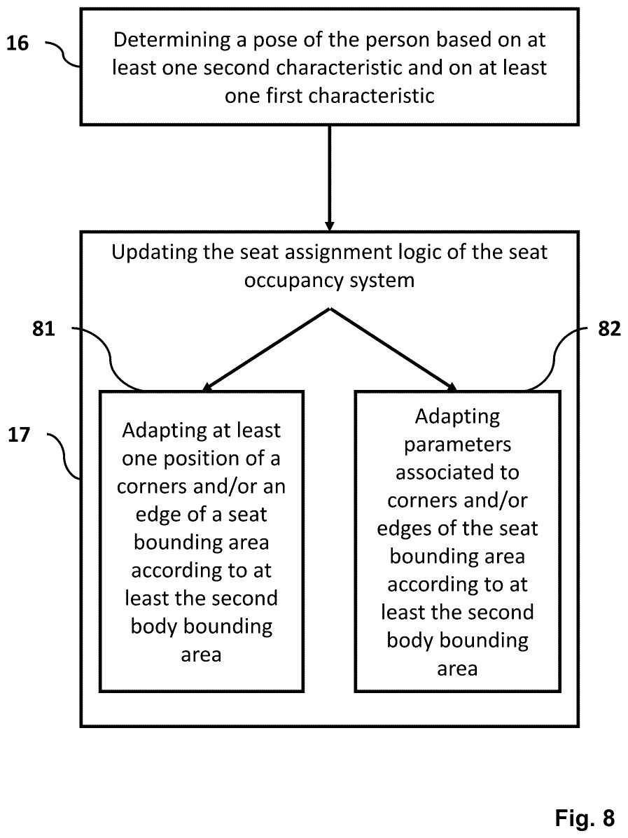

As explained above, the seat occupancy system is applied for the seat on a seat bounding area. This seat bounding area lies within images taken by the on-board camera. The leaning detection method of FIG. 1 may in one embodiment be used to update the seat bounding area associated with the seat in order to improve the seat occupancy detection and person-to-seat assignment when executed the next time. FIG. 8 depicts various implementations of how such an update of a seat bounding area may be achieved.

After determining that the person is leaning, e.g., after determining the pose in box 16 (as also depicted in FIG. 1), the seat assignment logic of a seat occupancy system is updated in box 17. Seat assignment logics of seat occupancy system determine whether a person or an object is to be assigned to a seat for determining a seat occupancy state of the seat. Different updates of such seat assignment logics may be considered, e.g., at least one of adapting corners and/or edges of the seat bounding area according to at least the second body bounding box (shown in box 81) and adapting parameters associated to corners and/or edges of the seat bounding area according to at least the second body bounding box. (shown in box 82). Although both updating processes are depicted in FIG. 8, an update according to the methods described herein may also only comprise one of them or even none of them but another update process, e.g., adapting parameters and corners at the same time or reshaping the bounding boxes or the like.

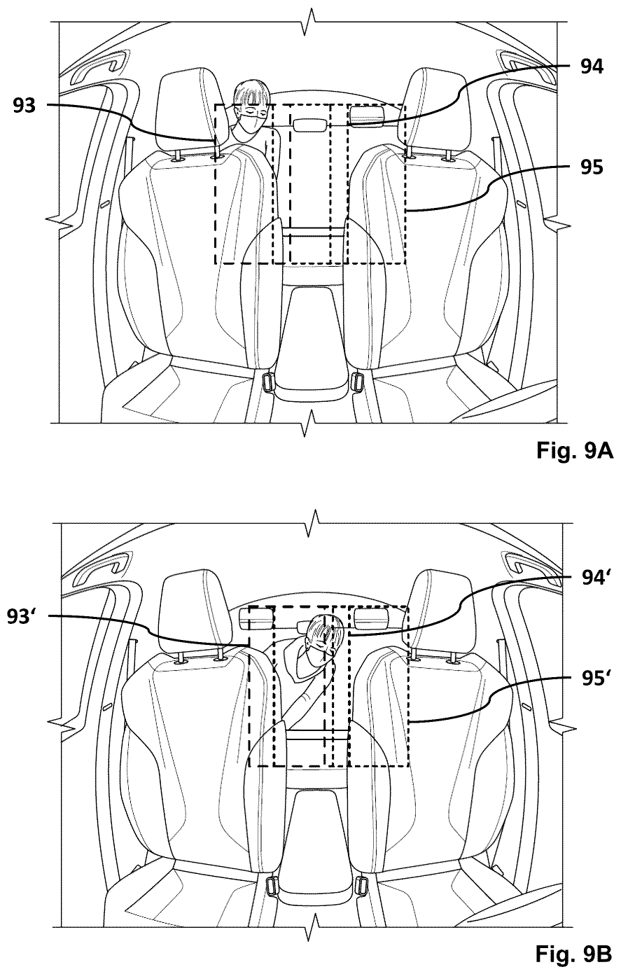

Adapting corner and/or edges of the seat bounding area, i.e., the process of box 81, is further illustrated in FIGS. 9A and 9B on the example of the rear seats. The left rear seat is associated to the seat bounding area 93, the middle rear seat is associated to the seat bounding area 94 and the left rear seat is associated with the seat bounding area 95, which are shown in FIG. 9A. In FIG. 9B, the seat bounding area 95′ associated with the left rear seat is moved to the right, since the person is leaning to the right. How much the corners and/or edges of the seat bounding area 95′ are moved to the right may be depending on the current body bounding area and/or the current face bounding area, e.g., relative to movement with respect to the previous or reference body and face bounding areas.

Adapting parameters associated to corners and/or edges of the seat bounding area, i.e., the process of box 82, may leave the corners and/or edges on the same positions as before, e.g., like shown in FIG. 9A, but reduces weight or parameters associated to the corners and/or edges so that a detected person, who can not clearly be assigned to the seat bounding area because he/she exceeds the seat bounding area exactly at the side/direction to which the person was determined to be leaning, can be clearly assigned as the exceeding on this side is weighted to be of less relevance for the seat occupancy system.

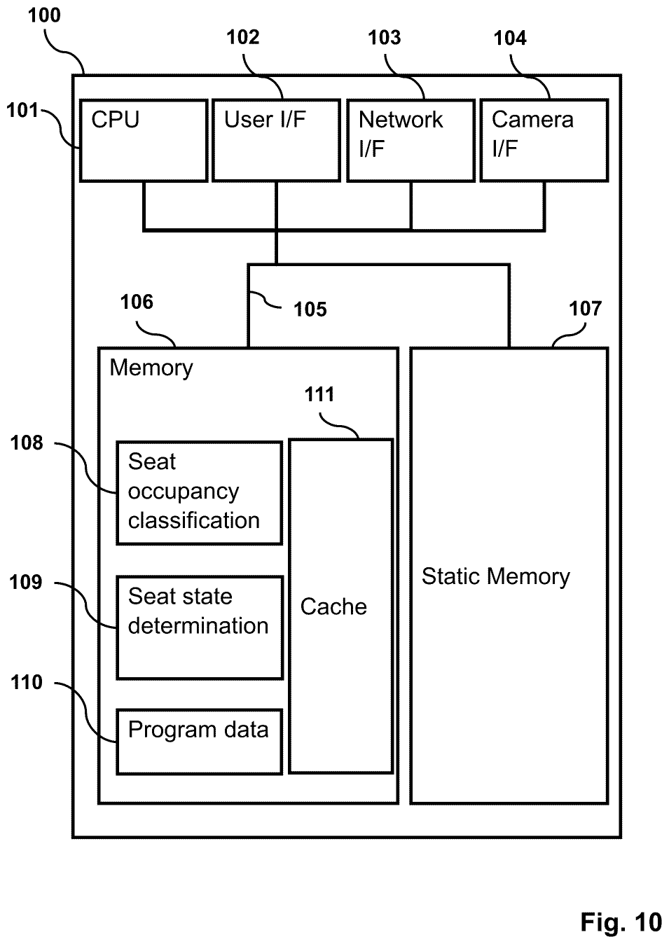

FIG. 10 is a diagrammatic representation of internal components of a computing system 100 implementing the functionality as described herein. The computing system 100 may be located in the vehicle and includes at least one processor 101, a user interface 102, a network interface 103 and a main memory 106, that communicate with each other via a bus 105. Optionally, the computing system 100 may further include a static memory 107 and a disk-drive unit (not shown) that also communicate with each via the bus 105. A video display, an alpha-numeric input device and a cursor control device may be provided as examples of user interface 102.

Furthermore, the computing system 100 may also comprise a specified camera interface 104 to communicate with an on-board camera of the vehicle. Alternatively, the computing system 100 may communicate with the camera via the network interface 103. The camera is used for taking the current image 1. The computing system 100 may also be connected to database systems (not shown) via the network interface, wherein the database systems store at least part of the images needed for providing the functionalities described herein.

The main memory 106, which may correspond to the memory 36 depicted in FIG. 3, may be a random-access memory (RAM) and/or any further volatile memory. The main memory 106 may store program code for the seat occupancy classification system 108 and the seat state determination system 109. The memory 106 may also store additional program data required for providing the functionalities described herein. Part of the program data 110, the seat state determination system 109 and/or the seat occupancy classification system 108 may also be stored in a separate, e.g., cloud memory and executed at least in part remotely. In such an example embodiment, the memory 106 may store at least one of current occupancy states, reference bounding areas, reference characteristics, faceID, and the like according to the methods describes herein. These may also be stored in a cache 111, which may again be located in a local or remote location.

According to an aspect, a vehicle is provided. The herein described seat state assignment method may be stored as program code 109 and may be at least in part comprised by the vehicle. The seat occupancy system may be stored as program code 108 and may also at least in part be comprised by the vehicle. Parts of the program code 108 may also be stored and executed on a cloud server to reduce the computational effort on the vehicle's computing system 100. The vehicle may also comprise a camera, e.g., connected via the camera interface 104, for capturing the current image 11.

According to an aspect, a computer program includes instructions is provided. These instructions, when the program is executed by a computer, cause the computer to carry out the methods described herein. The program code embodied in any of the systems described herein is capable of being individually or collectively distributed as a program product in a variety of different forms. In particular, the program code may be distributed using a computer readable storage medium having computer readable program instructions thereon for causing a processor to carry out aspects of the various implementations described herein.

Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer.

A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

It should be appreciated that while particular various implementations and variations have been described herein, further modifications and alternatives will be apparent to persons skilled in the relevant arts. In particular, the examples are offered by way of illustrating the principles, and to provide a number of specific methods and arrangements for putting those principles into effect.

In certain various implementations, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with various implementations of the invention.

The terminology used herein is for the purpose of describing particular various implementations only and is not intended to be limiting of the various implementations of the disclosure. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “include”, “having”, “has”, “with”, “comprised of”, or variants thereof are used in either the detailed description or the claims, such terms are intended to be inclusive in a manner similar to the term “comprising”.

While a description of various implementations has illustrated all of the inventions and while these various implementations have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, the described various implementations should be understood as being provided by way of example, for the purpose of teaching the general features and principles, but should not be understood as limiting the scope, which is as defined in the appended claims.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A computerized method of pose detection of a person in a vehicle, the method comprising:
receiving, from an on-board camera of the vehicle, an image of an interior of the vehicle showing a seat of the vehicle occupied by the person;
obtaining at least one first characteristic of a first face bounding area and a first body bounding area associated with the occupied seat of the vehicle;
determining a second body bounding area and an associated second face bounding area of the person from the image;
determining at least one second characteristic of the second face bounding area and the second body bounding area; and
determining a pose of the person based on the at least one second characteristic and on the at least one first characteristic.

2. The method of claim 1 wherein obtaining the at least one first characteristic includes retrieving the first face bounding area and the first body bounding area from a first memory based on a facial identification of the person.

3. The method of claim 1 wherein:
obtaining the at least one first characteristic includes retrieving the first face bounding area and the first body bounding area from a second memory; and
the first face bounding area and the first body bounding area are determined based on a mean position and/or mean area of face bounding areas and body bounding areas historically captured for persons on the seat.

4. The method of claim 1 wherein obtaining the at least one first characteristic includes determining the first face bounding area and the first body bounding area based on a mean position and/or mean area of face bounding areas and body bounding areas captured on a plurality of images of the interior of the vehicle for the person on the seat in a certain initialization period.

5. The method of claim 1 wherein:
the at least one characteristic includes a position of a face bounding area and a position of a body bounding area; and
determining the pose of the person includes:
calculating a left-right-leaning value of the person based on the position of the first face bounding area and the first body bounding area and the position of the second face bounding area and the second body bounding area, and
determining that the person is leaning right or left based on the left-right-leaning value.

6. The method of claim 1 wherein:
the at least one characteristic includes an area covered by a face bounding area and an area covered by a body bounding area; and
determining the pose of the person includes:
calculating a forward-backward-leaning value of the person based on at least two of the area of the first face bounding area, the area of the first body bounding area, the area of the second face bounding area, and area of the second body bounding area, and
determining that the person is leaning forward or backward based on the forward-backward-leaning value.

7. The method of claim 1 wherein the pose detection for a seat occupancy system is used to control safety functions in the vehicle.

8. The method of claim 1 wherein:
a graphical representation on a display within the vehicle is based on an output of a seat occupancy system, and
the output of the seat occupancy system is based on at least one of the pose detection, the second body bounding area, and the second face bounding area.

9. The method of claim 1 wherein the method is performed at a periodicity and/or in response to a person-to-seat assignment change of any of the seats in the vehicle.

10. The method of claim 1 wherein determining the pose of the person is performed on a periodic basis.

11. The method of claim 1 wherein determining the pose of the person is performed in response to detection of a person-to-seat assignment change of any seats in the vehicle.

12. A seat occupancy system in a vehicle, the system comprising:
storage configured to store executable instructions; and
a set of processors configured to execute the executable instructions, wherein the executable instructions include:
receiving, from an on-board camera of the vehicle, an image of an interior of the vehicle showing a seat of the vehicle occupied by a person;
obtaining at least one first characteristic of a first face bounding area and a first body bounding area associated with the occupied seat of the vehicle;
determining a second body bounding area and an associated second face bounding area of the person from the image;
determining at least one second characteristic of the second face bounding area and the second body bounding area; and
determining a pose of the person based on the at least one second characteristic and on the at least one first characteristic.

13. The seat occupancy system of claim 12 wherein the executable instructions include updating seat assignment data in response to determining the pose of the person.

14. The seat occupancy system of claim 13 wherein updating the seat assignment data includes adapting at least one of a corner position and an edge position of a seat bounding area according to at least a second body bounding box.

15. The seat occupancy system of claim 13 wherein updating the seat assignment data includes adapting parameters associated with at least one of corners and/or edges of the seat bounding area according to at least a second body bounding box.

16. A vehicle comprising:
the seat occupancy system of claim 12; and
the on-board camera.

17. A non-transitory computer-readable medium comprising instructions including:
receiving, from an on-board camera of a vehicle, an image of an interior of the vehicle showing a seat of the vehicle occupied by a person;
obtaining at least one first characteristic of a first face bounding area and a first body bounding area associated with the occupied seat of the vehicle;
determining a second body bounding area and an associated second face bounding area of the person from the image;
determining at least one second characteristic of the second face bounding area and the second body bounding area; and
determining a pose of the person based on the at least one second characteristic and on the at least one first characteristic.
